(19) United States
(12) Patent Application Publication
(10) Pub. No.: US 2004/0050556 A1
(43) Pub. Date: Mar. 18, 2004

(54) Fire suppression apparatus mixing foam and water and method of the same

(75) Inventors: Kenneth C. Baker, Mansfield, TX (US); Aron M. Grinman, Wayne, PA (US); Ashley A.G. Price, Collegeville, PA (US)

Correspondence Address: MERCHANT & GOULD PC, P.O. BOX 2903, MINNEAPOLIS, MN, 55402-0903, US

(73) Assignee: Kidde Fire Fighting, Inc., Exton, PA

(21) Appl. No.: 10/384,454

(22) Filed: Mar. 6, 2003

Related U.S. Application Data
(60) Provisional application No. 60/362,561, filed on Mar. 6, 2002.

(51) Int. Cl. A62C 35/00

(52) U.S. Cl. 169/15; 169/14; 169/13

(57) ABSTRACT

A fire suppression apparatus for mixing a first fluid, such as water, with a second fluid, such as foam, to be delivered through a fluid delivery line. A ratio controller is disposed within the delivery line and includes a first restriction area through which the first fluid passes, and that also accepts the second fluid. A fluid control mechanism is connected to the ratio controller, and includes a second restriction area. The fluid control mechanism delivers the second fluid to be mixed with the first fluid in the delivery line. A pressure sensing module measures the pressures of the first and second fluids. A control computer processes the pressures measured from the pressure sensing module, and maintains the pressure of the second fluid equal to the pressure from the first fluid. The first restriction area and the second restriction area define a ratio that determines a flow amount of the second fluid. The pressure sensing module may include two pressure transducers, a first pressure transducer to measure the pressure of the first fluid and a second pressure transducer to measure the pressure of the second fluid. The apparatus may be capable of drawing the second fluid a vertical distance of at least six feet from a second fluid source. The apparatus may be suitable for use with second fluids having a wide range of viscosities and desired relative flow amounts. The apparatus may be made in kit form, with the components thereof arranged together in modules for convenient assembly, transport, installation, and use.

### RELATED APPLICATION

This application claims the benefit of U.S. Provisional Application No. 60/362,561, filed Mar. 6, 2002 and entitled FIRE SUPPRESSING DEVICE MIXING FOAM AND WATER AND METHOD OF MIXING FOAM AND WATER, which is in its entirety incorporated herewith by reference.

This application also incorporates by reference in its entirety U.S. Provisional Application No. (serial number not available as of filing), filed Mar. 6, 2003 and entitled APPARATUS & METHOD FOR COMPARING AND CONTROLLING PRESSURES, attorney docket number 13867.18USP1.

### FIELD OF THE INVENTION

This invention relates to an apparatus and method for mixing fluids. More particularly, the invention relates to an apparatus for mixing foam and water for fire suppression, and a method of mixing foam and water for fire suppression.

### BACKGROUND OF THE INVENTION

Fire fighting devices are well known and have been widely used. Typically, a fluid such as water is thrown or sprayed upon a fire zone to extinguish a fire. Such systems include a fluid source having a discharge line attached to the fluid source so that water can be delivered to the fire area. A pressure apparatus provides the necessary pressure to throw the water onto the fire in attempt to extinguish the fire.

Advances have been made using a mixture of a foam concentrate with water in fighting fires. Typically, these systems employ a fluid source delivering water from a water supply to a discharge line. A foam source delivers a foam concentrate to be mixed with water in the discharge line. The mixture provides a more effective fire fighting composition by wetting the fire and suppressing oxygen to the fire. In addition, proportioning systems have been used to produce the necessary percentage of foam in a mixture of foam and water to fight fires. Typically, these systems included a flow meter to determine water flow and a control processor to drive a foam pump at the proper speed to inject the proper amount of concentrate into the discharge line to mix with water for discharge.

However, in addition to other shortcomings, these systems still exhibit proportioning problems. Such inaccuracies in providing a proper percentage of foam for a foam and water mixture leads to waste in product and a less cost effective system. Therefore, there is a need for an improved fire suppression device in which an accurate amount of foam is mixed with water in precise percentages that is cost effective with the product used, while maintaining a suitable mixture to fight and put out fires.

In addition, conventional fluid mixing apparatus typically are adapted to be used only in systems specifically designed to incorporate them. For example, unless a firefighting vehicle was designed originally to include a foam system, it is difficult to add a conventional foam system later. Such conventional systems normally require dedicated foam cells to act as foam sources, and/or may require electrical and/or hydraulic connections that are integrated into the vehicle itself, etc.

Likewise, conventional systems are not well-adapted for use as portable or self-contained units, and may be difficult or complex to assemble regardless.

Furthermore, conventional foam systems typically are adapted to operate only within relatively narrow circumstances.

For example, conventional systems are gravity fed. Consequently, the foam reservoir in a conventional system must be located above the foam pump. In practice, foam cells conventionally are located atop firefighting vehicles. However, such a foam cell must be filled from atop the vehicle, which may not always be convenient.

Also, due in part to their need for dedicated foam cells, conventional systems typically are limited to only a single foam source. In some circumstances, it may be desirable to select the most appropriate foam or other fluid from among several options. However, conventional systems cannot easily be made to provide such flexibility, since it would require multiple foam cells, each dedicated to a single type of foam.

Furthermore, conventional systems typically are suited only for a relatively narrow range of fluids, even if two or more fluids can be provided thereto. For example, various firefighting foams have different viscosities, different preferred mix ratios, etc. Conventional systems are suited to a relatively narrow range of viscosities, and can accurately dispense fluids only in a relatively narrow range of mix ratios.

### SUMMARY OF THE INVENTION

The present invention relates to an apparatus for mixing fluids, in particular for mixing foam and water for fire suppression.

In one exemplary embodiment, an apparatus for mixing fluids in accordance with the principles of the present invention includes a fluid delivery line adapted to communicate with a first fluid source. A ratio controller is disposed within the fluid delivery line. The ratio controller includes a first restriction area adapted to receive a second fluid.

A flow control valve is in communication with the fluid delivery line at the first restriction area. The flow control valve includes an area controlling device having an adjustable second restriction area.

An electrically driven fluid pump introduces the second fluid from a second fluid source. The fluid pump is connected to the flow control valve to deliver the second fluid to the first restriction area via the second restriction area.

A pressure sensing module is used to sense the pressure of the first fluid upstream of the first restriction area, and to sense the pressure of the second fluid upstream of the second restriction area.

An interface is used for setting a relative flow amount of the second fluid compared to the first fluid.

A control computer is arranged in communication with the pressure sensing module and the fluid pump. The control computer processes the pressures measured from the pressure sensing module, and sends command signals to the fluid pump to modulate the pressure of the second fluid such that the pressure of the second fluid is maintained substantially equal to the pressure of the first fluid.

As a result, when the pressures of the first and second fluids are substantially equal, the ratio of the first restriction area to the second restriction area determines the relative flow amount of the second fluid compared to the first fluid.

With regard to the term “restriction area”, it is emphasized that this term is used broadly. With the fluid valve in full open position, in some embodiments the second restriction area may be restricted slightly, if at all. Likewise, although for certain embodiments it may be advantageous for the first restriction area to be actually reduced in size as compared with nearby portions of the delivery line, this is exemplary only, and is not required. Thus, although restriction areas may in fact be physically restricted, the term as used herein does should not be interpreted to mean that restriction areas necessarily are or must be physically restricted.

In addition, the term “substantially equal” is used as a functional definition, used in recognition of the fact that in any real physical system no two pressures are exactly equal. Even within a given volume of fluid, local pressure variations may occur. However, pressures are considered to be substantially equal for purposes of this application if the pressures are sufficiently close that the device adequately mixes the second fluid with the first in the desired proportion.

The sensing module may include first and second pressure transducers, the first pressure transducer sensing the pressure from the flow of the first fluid from the first fluid source, and the second pressure transducer sensing the pressure from the flow of the second fluid from the second fluid source. In such embodiments, the control computer processes the pressures measured from the first and second pressure transducers.

Gravity feed for the second fluid source may not be required. In certain embodiments, the pump may generate sufficient force to pull the second fluid upward a vertical distance from the second fluid source. Furthermore, in some embodiments this vertical distance may be at least six feet.

Certain embodiments of the apparatus may be adapted to utilize a range of second fluids. For example, some embodiments may be able to use type A firefighting foam and type B firefighting foam. Likewise, some embodiments may be able to controllably dispense second fluids in a wide range of concentrations, for example 0.1% to 3%. It is noted that such a range is suitable for both type A firefighting foams, which conventionally are used at concentrations of 0.1% to 1%, and type B firefighting foams, which conventionally are used at concentrations of 1% to 3%.

The valve may be constructed so as to have a valve body defining an outflow opening therein, and a valve stem having an end thereof disposed at least partially in the outflow opening so as to control a flow of the second fluid therethrough. Thus the outflow opening and the valve stem end cooperate to form the second restriction area, and the area of the second restriction area is a portion of the outflow opening that is unobstructed by the valve stem end.

The valve stem may include a helical groove defined therein. A positioning pin may be connected to the housing and engaged with the helical groove, such that rotating the valve stem causes the stem to move linearly so as to change the portion of the outflow opening that is unobstructed by the valve stem end.

The pitch of the helical groove may be limited to not more than 0.003 inches of linear travel per degree of rotation. Alternatively, the pitch of the helical groove may be sufficiently shallow as to avoid linear movement of the valve stem due to operating pressures from the first and/or second fluids. The pitch may vary along the length of the helical groove.

Electrical connections in some embodiments of the apparatus may be made using plug connectors, in particular waterproof and/or unique plug connectors.

Certain embodiments of the apparatus may be arranged as a control module and an active module.

Embodiments of the apparatus also may be disposed on skids, or similar carriages.

The present invention also relates to a kit for a fluid mixing apparatus. In one exemplary embodiment, a kit for a fluid mixing apparatus in accordance with the principles of the present invention includes a control module, a flow control valve, and an active module.

The control module includes an interface for setting the relative flow amount of a second fluid compared to a first fluid.

The flow control valve is in communication with the interface, and is adapted to receive the second fluid. The flow control valve has an adjustable second restriction area. In certain embodiments, the flow control valve also may be part of the control module.

The active module includes a ratio controller adapted to be disposed within a fluid delivery line for the first fluid from a first fluid source. The ratio controller includes a first restriction area through which the first fluid passes, that is also adapted to receive the second fluid via the second restriction area.

The active module also includes an electrically driven fluid pump adapted to introduce the second fluid from a second fluid source. The fluid pump is connected to the flow control valve to deliver the second fluid to the first restriction area via the second restriction area.

The active module further includes a pressure sensing module for sensing the pressure of the first fluid upstream of the first restriction area, and for sensing the pressure of the second fluid upstream of the second restriction area.

The active module additionally includes a control computer in communication with the pressure sensing module and the fluid pump. The control computer processes the pressures measured from the pressure sensing module, and sends command signals to the fluid pump to modulate the pressure of the second fluid such that the pressure of the second fluid is maintained substantially equal to the pressure of the first fluid.

As a result, when the pressures of the first and second fluids are substantially equal, a ratio defined by the first restriction area to the second restriction area determines the relative flow amount of the second fluid compared to the first fluid. The present invention also relates to a method for mixing fluids. In one exemplary embodiment, a method in accordance with the principles of the present invention includes the step of providing a delivery line having a first restriction area. A first fluid is introduced into the delivery line at a first pressure.

A fluid control for a second fluid is provided. The fluid control mechanism includes an electrically driven fluid pump and a flow control valve with an adjustable second restriction area.

A second fluid is introduced at a second pressure for delivery to the first restriction area via the second restriction area.

The first and second fluid pressures are measured with a pressure sensing module, and the first and second fluid pressures measured by the pressure sensing module are processed using a control computer.

A feedback loop is provided between the control computer and the fluid pump. Command signals are send from the control computer to the fluid pump to maintain the second fluid pressure substantially equal to the first fluid pressure. Thus, the relative flow amount of the second fluid to the first fluid is a ratio of the first restriction area to the second restriction area. By virtue of this, the relative amount of the second fluid to the first fluid is controlled by controlling the second restriction area.

These and other various advantages and features are pointed out in the following detailed description. For better understanding of the invention, its advantages, and the objects obtained by its use, reference should also be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 represents a schematic view of one embodiment of a fire suppression device according to the principles of the present invention.

FIG. 2 represents a schematic view of a portion of the fire suppression device of FIG. 1 including a fluid control valve in a close position.

FIG. 3 represents a schematic view of a portion of the fire suppression device of FIG. 1 including a fluid control valve in an open position.

FIG. 4 represents an example process flow diagram for a control module.

FIG. 5 represents a perspective view of an exemplary embodiment of a fire suppression device according to the principles of the present invention.

FIG. 6 represents a cutaway view of an exemplary embodiment of a valve suitable for use in a fire suppression device according to the principles of the present invention.

### DETAILED DESCRIPTION OF THE PREFERRED EMBODIMENT

In the following description of the illustrated embodiments, reference is made to the accompanying drawings that form a part hereof, and in which is shown by way of illustration of various embodiments in which the invention may be practiced. It is to be understood that other embodiments may be utilized, as structural changes may be made without departing from the spirit and scope of the present invention.

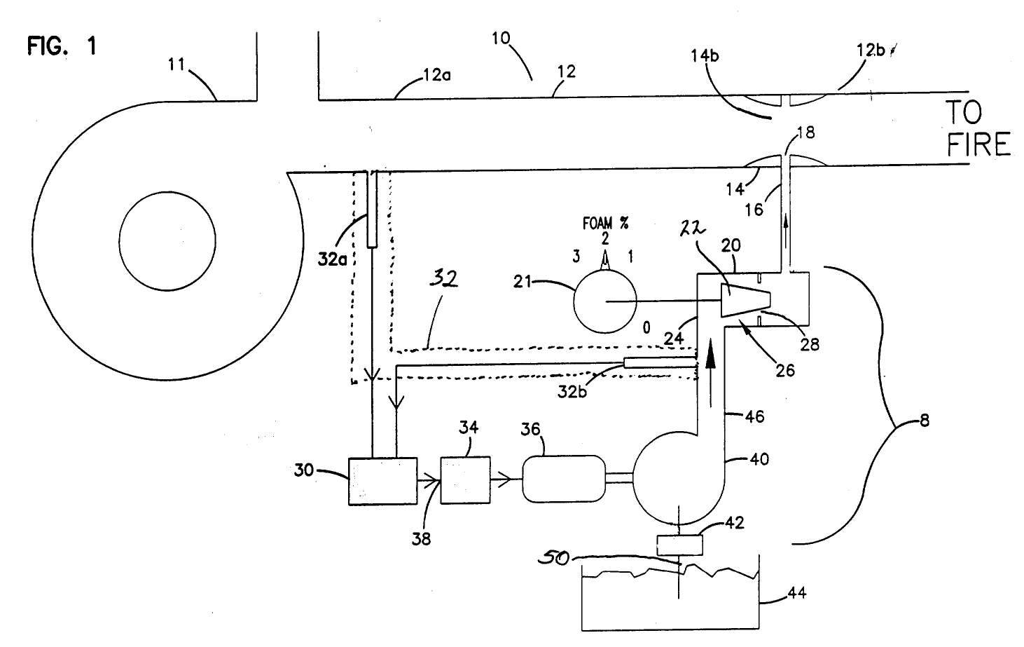

FIG. 1 illustrates one example of a preferred fire suppression apparatus 10 for mixing foam and water according to the principles of the present invention. The fire suppression apparatus 10 includes a fluid delivery line 12 having an upstream portion 12a and a downstream portion 12b. The upstream portion 12a may be suitably adapted for attachment to a fluid source for delivering a first fluid and the downstream portion 12b includes an outlet for fluid delivery to a fire. As shown in FIG. 1, the upstream portion 12a is suitably attached with a water source 11 allowing water flow to the fluid delivery line 12 at the upstream portion 12a.

A ratio controller 14 is defined within and extending towards the downstream portion 12b about an inner sidewall of at least a portion of the fluid delivery line 12. Preferably, the ratio controller 14 refers to a diameter along a portion of the fluid delivery line 12. At the downstream portion 12b of the fluid delivery line 12 a first restriction area 14b resides on an inner sidewall within the ratio controller 14 of the fluid delivery line 12.

The first restriction area 14b represents a venturi section. Preferably the first restriction area is a tapered restriction. More preferably, the first restriction area 14b is a smooth tapered restriction, as shown in FIG. 1. The first restriction area 14b gradually increases from the upstream end toward a center or vortex 18 and gradually decreases from the center 18 to the downstream end. The vortex 18 of the ratio controller defines a low pressure area where a ported annulus 16 is provided to permit outside access to the low pressure area.

Preferably, the ratio controller includes a diameter size of 2.0 to 8.0 inches. More preferably, the diameter of the ratio controller is 2.5 inches. Preferably, the diameter of the first restriction is 1.155 inches at a center of the first restriction area 14b when diameter of the ratio controller is 2.5 inches. It will be appreciated that the size or diameter of the first restriction area may vary according with the size or diameter of the ratio controller and desired configuration.

A fluid control mechanism 8 delivers a second fluid to mix with the first fluid. The fluid control mechanism 8 includes a fluid control valve 20, and an electrically driven fluid pump 40. Preferably, as shown in FIG. 1, the fluid control valve 20 and the fluid pump 40 are configured to deliver and meter a flow of a second fluid. A fluid source 44 provides a supply of the second fluid. The fluid may be delivered from the fluid source 44 to the fluid pump 40 by a variety of conveyances, such as pick up tube 50 as shown in FIG. 1. A filter 42 also may be employed to filter the second fluid before being drawn by the fluid pump 40. In some embodiments, such as that shown in FIG. 1, the filter 42 may be disposed partway along the length of the pick up tube 50, but this is exemplary only. The fluid control mechanism 8 is connected to the fluid delivery line 12 and ratio controller 14 through the ported annulus 16 of the first restriction area. The fluid pump 40 delivers a supply of the second fluid from the fluid source 44 to the inlet 24 of the fluid control valve 20.

Preferably, the first fluid is water and the second fluid is foam concentrate. It will be appreciated that the first and/or the second fluids can be other types of fluids as well.

An interface 21 suitable to be operatively connected to the fluid control valve 20 controls the opening and closing of the fluid control valve 20 to adjust the flow of the second fluid to be mixed with the first fluid to a desired percentage. One example of a suitable interface is a dial, as shown in FIG. 1, having percentage settings at 0%, 1%, 2%, and 3%. However, it will be appreciated that different interface types may be employed other than a dial and that the number of settings and their values may be modified. In particular, interfaces other than manual interfaces may be suitable. For example, for certain embodiments electronic or computer controlled interfaces may be suitable for use with the claimed invention.

The fluid control valve 20 includes an area control device 26 and a second restriction area 28. Preferably, the area control device 26 is a valve head 22. The relationship between the first restriction area 14b of the ratio controller 14 and the second restriction area 28 enables a flow of the second fluid to be accurately controlled as a ratio of the first fluid. This relationship will be further described below.

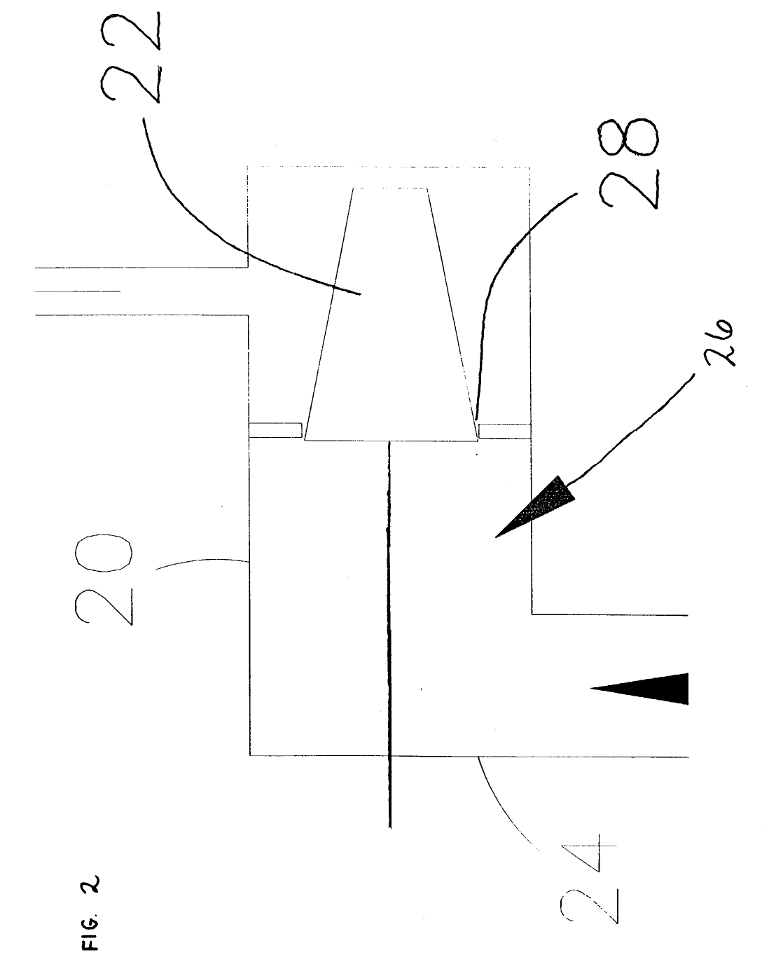

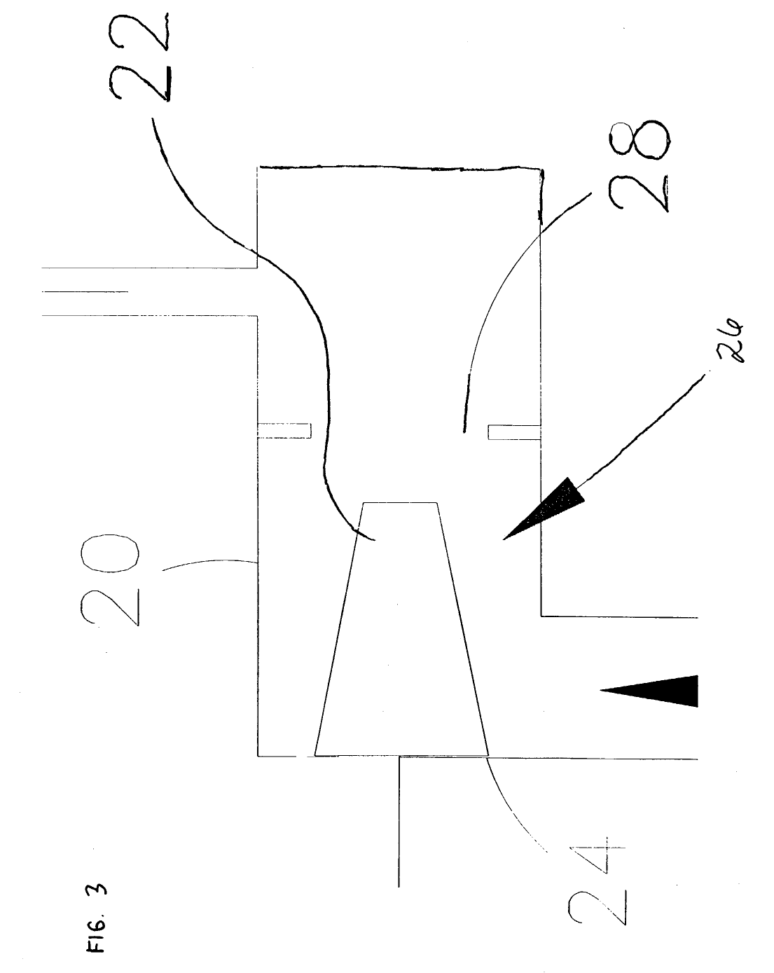

Preferably, the second restriction area 28 is made variable by the valve head 22. More preferably, the valve head 22 is a variable cone valve that varies the second restriction area 28 within the metering valve. It will be appreciated that the second restriction area 28 is adjustable and can infinitely vary from a fully closed position and a fully open position of the variable cone valve, as shown in FIGS. 2 and 3. The cone valve may be calibrated based on the desired percent of total flow of the first fluid and the second fluid combined. Further, the cone valve dimensions can be modified as desired to provide the proper cone angle and dimensions intended for use on a first fluid such as water or a second fluid such as foam concentrate.

The fire suppression apparatus 10 preferably includes at least one pressure transducer used to measure the pressure of the first and/or second fluid. As illustrated, a pressure sensing module 32 measures the pressure at which the first fluid such as water is delivered. Preferably, as shown in FIG. 1, the pressure sensing module 32 measures the pressure of the first fluid at the upstream portion 12a of the fluid delivery line. The pressure sensing module 32 also measures the pressure at which the second fluid such as foam concentrate is delivered. Preferably, as shown in FIG. 1, the pressure sensing module 32 measures the pressure of the second fluid at the inlet 24 of the fluid control valve 20, upstream from the second restriction area (see below), and senses a pressure of the second fluid after it is discharged from the fluid pump 40.

In some embodiments, the pressure sensing module 32 may include first and second pressure sensing transducers 32a and 32b, for measuring the first and second fluid pressures respectively. As illustrated in FIG. 1, the first pressure transducer 32a measures the pressure at which the first fluid such as water is delivered. Preferably, as shown in FIG. 1, the first pressure transducer is disposed at the upstream portion 12a of the fluid delivery line. The second pressure transducer 32b measures the pressure at which the second fluid such as foam concentrate is delivered. Preferably, as shown in FIG. 1, the second pressure transducer 32b is disposed at the inlet 24 of the fluid control valve 20, and senses a pressure of the second fluid after it is discharged from the fluid pump 40.

However, embodiments wherein the pressure sensing module 32 includes first and second pressure sensing transducers 32a and 32b are exemplary only. It may be equally suitable to use pressure a sensing module that does not include first and second pressure sensing transducers. Although for purposes of clarity a two-transducer pressure sensing module is illustrated and described herein in detail, other arrangements may be equally suitable.

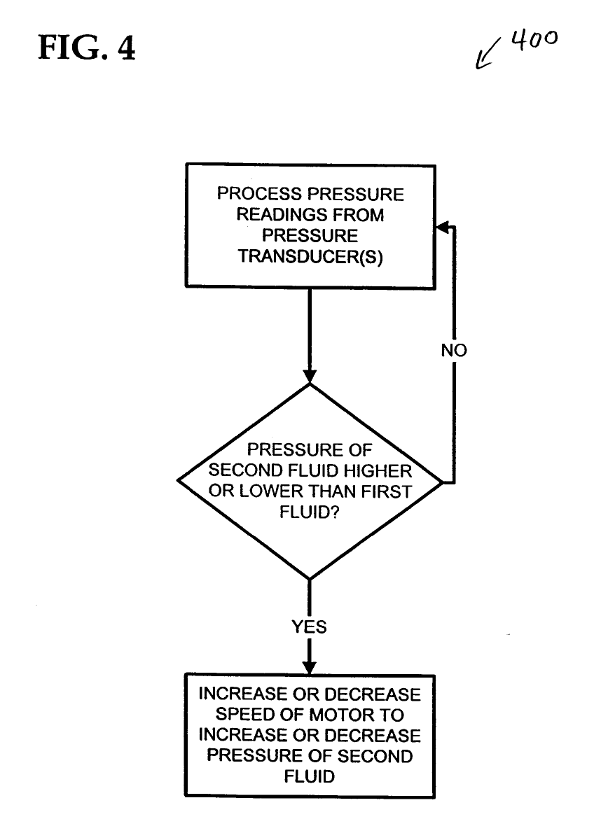

A control computer 30 processes the pressure measurements of the first and second fluids. Where a difference in the pressures of the first and second fluids is indicated, command signals are transmitted back to the fluid control mechanism 8 to maintain the pressure of the second fluid equal to the pressure of the first fluid, as shown in the process flow diagram 400 of FIG. 4.

Preferably, the control computer 30 provides an active feedback loop to the fluid pump 40 of the fluid control mechanism 8 to control the second fluid pressure. More preferably, the control computer 30 uses an algorithm to control the speed of a motor drive 34 and motor 36 and to modulate the pressure of the second fluid delivered by the fluid pump 40.

Preferably the control computer 30 is a programmable logic controller (PLC), or the like.

Preferably, the motor drive 34 is a variable speed motor drive that electrically drives the fluid pump 40 to provide pressure to the second fluid. More preferably, the motor drive accepts either Analog (0-8 vdc) or Pulse Width Modulated (0-100%) control input and provides an appropriately converted and proportionate output to the motor.

Preferably, the fire suppression apparatus 10 includes proportioning rates for mixing foam with water in the range of 0.1% to 3.0% foam. For instance, proportioning rates may include 100 gallons per minute (GPM) at 3.0% foam, 150 GPM at 2.0% foam, 300 GPM at 1.0% foam, and 600 GPM at 0.5% foam. The fire suppression apparatus 10 is suitable for use with both Class A, Class B, and other foam concentrates. In addition, it will be appreciated that modifications may be made accordingly with respect to piping arrangement, including piping configuration and pipe size, to accommodate differences in flow characteristics of particular foam concentrates used to prevent problems such as adhesion in maintaining accurate flow proportions.

In order for the ratio controller 14 including the first restriction area 14b to operate properly, the pressure of the first fluid and the pressure of the second fluid must be equal. The ratio controller 14 functions in the following manner. When the first fluid encounters the first restriction area 14b with a known area, and a second fluid is fed into the first restriction area after being supplied to the inlet 24 of the fluid control valve 20 with a pressure that is equal to the pressure of the upstream first fluid flow, the second fluid flow introduced at the ported annulus 16 of the first restriction area 14b of the ratio controller 14 will be inducted into the first fluid flow in a ratio of the area of the first restriction area 14b of the first fluid flow to the area of the second restriction area 28 for the second fluid flow.

As described above, the area of the second restriction area is preferably made variable, and controlling the flow of the second fluid as a ratio of the first fluid can be easily attained. The ratio will remain constant at any area setting for the second restriction area with high stability over wide excursions of a first fluid pressure and flow value. To achieve this condition, both the first fluid and the second fluid are preferably maintained at approximately the same pressure (i.e. in a balanced pressure configuration).

A typical method used to modulate a motor drive and motor is proportional band, integral, and derivative (PID). A proportionate system is one in which a change in control input or pressure error will create a proportionate control output change to a process controlling device such as a variable speed motor drive and motor.

In contrast, a preferred embodiment of the present invention provides a pressure error value that is not consistent with the output change required to drive the system to zero pressure error.

The control computer 30 preferably employs an algorithm for controlling the motor drive 34 and motor 36. A variety of algorithms may be suitable. For example, in an exemplary embodiment the algorithm might be such that a small control output change is made and the resultant reduction in error is analyzed mathematically and, by ratio and proportion, a new control output change sufficient to reduce the pressure error to zero is calculated and implemented. Preferably, the algorithm functions to reduce the pressure error to a very small value within two steps, even in a non-linear system.

Specific algorithms suitable for controlling a motor drive 34 and motor 36 by a computer are known per se, and are not further described herein.

However, this arrangement is exemplary only, and other types of algorithms may be equally suitable.

In addition, the control computer 30 preferably provides a feedback loop to maintain the fluids at substantially equal pressures. For example, the control computer 30 may process the pressures measured from the first and second pressure transducers 32a and 32b, and send command signals to the fluid pump 40 through the drive 34 means so as to keep the fluids at similar pressures.

However, this arrangement is exemplary only, and other feedback loops may be equally suitable. Feedback loops are known per se, and are not further described herein.

The various logical components of the control computer 30 can be implemented in software or firmware.

In addition, the fire suppression apparatus preferably includes a smoothing mechanism for smoothing the signals from the pressure transducers 32a and 32b. The smoothing mechanism is adapted to smooth out noise in the signals from the pressure transducers 32a and 32b, so as to produce a smooth signal that may be readily processed and used.

It is noted that, as the term is used herein with regard to smoothing, “noise” is meant to refer to any sharp peaks or valleys in the signals. Such peaks and valleys may be produced by a variety of sources. In some instances, noise may be representative of real but transient changes in pressure. In other instances, noise might be caused by the transducers themselves, fluctuations in the power supplied to the transducers and/or other components, electromagnetic interference from internal or external sources, etc. All such disturbances are included in the concept of signal noise, regardless of their precise source.

Smoothing may be accomplished in a variety of manners. For example, an algorithm may be used to smooth a pressure signal by taking pressure measurements at regular intervals, and calculating a moving average of several consecutive measurements. Such a moving average reflects the mean value of the pressure over time, but is less sensitive to noise, i.e. transient fluctuations in pressure.

The above example is illustrative only. Smoothing algorithms need not be simple moving averages. Other statistical methods may also be used. Where algorithms are used for smoothing, a variety of such algorithms may be suitable. Smoothing algorithms are known per se, and are not described further herein.

However, the smoothing mechanism is not limited to algorithms only. Smoothing may be accomplished in other ways, including but not limited to the use of electrical circuits to smooth a signal directly, without the need for an algorithm. For example, certain passive LC circuits may be used to eliminate or reduce high frequency components of a signal. An algorithm as such is not required in such instances, since the changes to the signal passing through a passive circuit are inherent to the structure of the circuit. LC circuits for signal smoothing also are known per se, and are not described further herein.

It is noted that signal smoothing may be accomplished while the signal is in either digital or analog form. Thus, smoothing is not dependent on whether the signal at any given point is analog or digital, and there is no requirement that any particular component of the system must be either analog or digital. With regard to the examples above, algorithms may be particularly suitable for use with digital signals, while passive smoothing may be particularly suitable for use with analog signals. However, this is exemplary only.

In addition, the location and/or component wherein signal smoothing is accomplished may vary. For example, the control computer 30 may include smoothing logic, such as a moving average algorithm as described above. Alternatively, smoothing may be implemented in the transducers 34a and 34b themselves. Likewise, smoothing may be accomplished elsewhere, i.e. by dedicated components disposed between the transducers 34a and 34b and the control computer 30.

The control computer 30 may drive the motor 36 in various ways. For example, the control computer 30 may use Pulse Width Modulation (PWM) to vary the voltage and/or current applied to the motor 36.

Conventional digital systems operate only at discrete levels, i.e. 0 or 5 volts. Values between those discrete levels cannot be produced directly. With PWM, a digital signal is cycled on and off so as to produce an output which, over time, has a desired average value. For example, if a digital system capable of an output of 0 or 5 volts were cycled on and off so that it were on 50% of the time, the average voltage would be 2.5 volts. Varying the amount of time that the system is on (its “duty cycle”) allows any effective output from 0 to 5 volts to be produced.

In this manner, a digital signal can be used to produce continuously outputs that are received by analog devices as continuously variable (i.e. analog) signals. Thus, a digital device using PWM may be used to directly control an analog device, without the disadvantages involved in actually converting the digital signal to an analog signal (i.e. the need for a digital to analog converter, loss of the noise resistance of the original digital signal, etc.) Furthermore, PWM may provide operational advantages, i.e. precise control over motor speed can be maintained, and the electric motor 36 can provide nearly constant torque at low speeds with no cogging.

PWM is known per se, and is not further described herein.

However, the use of PWM is exemplary only. In other embodiments, a digital signal from the control computer 30 may be converted to an analog signal using a digital to analog converter, the analog signal then being applied to the motor 36. Alternatively, the motor 36 may be adapted to accept digital signals directly. Furthermore, the control computer 30 may be adapted to directly generate an analog signal. Other arrangements for driving the motor 36 also may be equally suitable.

As shown in FIG. 1, the present invention may be suitably retrofitted for the injection of a second fluid, such as a foam concentrate, into existing water-only based fire fighting systems. For example, the present invention may be employed as a retrofit for a fire truck discharge line.

In certain embodiments of a system in accordance with the principles of the claimed invention, including but not limited to embodiments intended for use in such retrofits, the fluid pump 40 may be adapted to draw fluid some vertical distance upward from the fluid source 44. For example, the fluid pump 40 may be adapted to draw a vacuum, so as to pull the fluid into the fluid pump 40 from some distance away, such as through a pick up tube 50 leading from the fluid source 44.

In a preferred embodiment, the fluid pump 40 is adapted to draw fluid a vertical distance of at least 6 feet from the fluid source 44.

In embodiments wherein the pump 44 can draw fluid a vertical distance from the fluid source 44, it is not necessary to arrange the fluid source 44 above the level of the fluid pump 40 so as to allow for gravity feed of the fluid. Likewise, it is not necessary to pressurize the fluid source 44, or to otherwise make special provisions for fluid source.

For example, in an exemplary embodiment wherein the first fluid is water and the second fluid is a foam concentrate, the use of a pump adapted to draw a vacuum enables the use of the system without a dedicated foam cell, such as is found on some firefighting vehicles. Instead, the fluid source 44 may be a simple foam “bucket” or other simple reservoir. In addition, it is not necessary with such an embodiment to locate the fluid source 44 above the fluid pump 40, as is done conventionally (though such an arrangement is not precluded). Instead, the fluid source 44 may be disposed, for example, on the ground, in a storage area within a firefighting vehicle, in a dedicated skid or other enclosure, etc.

In addition, in embodiments wherein the pump 40 is adapted to draw the fluid from the fluid source 44, the pick up tube 50 may be a simple tube, and connection may be accomplished merely by immersing one end of the pick up tube 50 in the fluid that is in the fluid source 44.

It is noted that embodiments wherein the pump 40 can draw fluid a vertical distance from the fluid source 44 may be readily suited for retrofitting, since it is not necessary to add a dedicated foam cell; instead, the fluid source 44 may be substantially any vessel capable of holding the desired fluid.

Furthermore, it is noted that a pump 40 capable of producing a vacuum sufficient to draw fluid a vertical distance from a fluid source 44 also may be advantageous for other reasons. For example, as the viscosity of a fluid increases, its resistance to flow through tubing, pumps, etc. also typically increases. Thus, the ability to exert force sufficient to draw fluid a vertical distance may be useful in pumping fluids of high viscosity, and consequently such embodiments of the system may be especially suitable for use with fluids having a high viscosity.

A variety of pumps 40 may be suitable for drawing fluid in the manner described. In a preferred embodiment, the pump 40 may be a rotary vane pump. In a more preferred embodiment, the pump 40 may be a rotary vane pump having centrifugal vanes that extend to engage the inner walls of the pump, so as to draw a vacuum. However, this is exemplary only, and other pumps may be equally suitable.

In some embodiments of a system in accordance with the principles of the claimed invention, the fluid control valve 20 may be adapted to reliably produce a relatively broad range of mix ratios. It is noted that conventional class A foams typically are added to water in concentrations of 0.1% to 1%, while conventional class B foams typically are added in concentrations of 1% to 3%. Thus, as an example, it may be advantageous to utilize a fluid control valve 20 that is adapted to reliably produce fluid concentrations suitable for both class A and class B foams, that is, concentrations ranging from 0.1% to 3%.

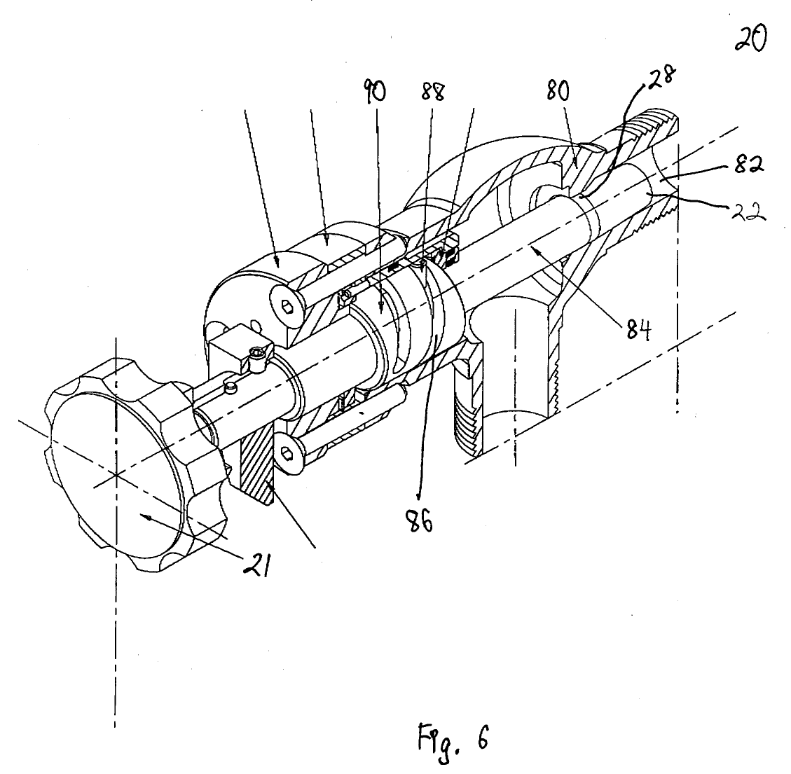

An exemplary embodiment of a suitable fluid control valve 20 is illustrated in FIG. 6. As shown, the fluid control valve 20 includes a valve body 80. The valve body defines an outflow opening 82 therein. A valve stem 84 is disposed within the valve body, such that an end of the valve stem 84 is at least partially disposed in the outflow opening 82.

Thus in this exemplary embodiment, the end of the valve stem 84 serves as the valve head 22, and the valve head 22 and the opening 82 cooperate to define the second restriction area 28.

As illustrated, the valve head 22 is in the shape of a truncated cone, such that the fluid control valve 20 is a variable cone valve. However, this is exemplary only, and other types of valve may be equally suitable.

The valve stem 84 defines a helical groove 86 therein. The fluid control valve 20 also includes a positioning pin 88 connected to the valve body 80. The positioning pin 88 engages the helical groove 86, such that rotating the valve stem 84 causes the valve stem 84, and in particular the valve head 22 at the end of the valve stem 84, to move linearly. As the valve head 22 moves linearly into or out of the outflow opening 82, the size of the second restriction area 28 changes.

Such an arrangement of a positioning pin 88 in a helical groove 86 enables precise control of the position of the valve head 22 within the outflow opening 82, and consequently enables precise control of the size of the second restriction area 28. Since, as described elsewhere, when the pressures of the first and second fluids are substantially equal the relative flow amount of the second fluid compared to the first fluid is determined by the ratio of the size of the second restriction area to the size of the first restriction area, such an arrangement also enables precise control of the relative flow amount of the second fluid.

This is in part because a helical groove 86 permits a relatively long travel for a relatively short adjustment in linear position of the valve head 22. In other words, the total length of the helical groove 86 typically is many times larger than the total stroke length of the valve head 22.

The degree of precision of such control is determined in part by the relative length of the helical groove 86 as compared with the stroke length for the valve head 22. As the relative length of the helical groove 86 increases, the position of the valve head 22 can be controlled more finely.

The length of the helical groove 86 is in turn determined in part by the groove pitch, i.e. the linear extent of the groove along the body of the valve stem for a given angular rotation. A smaller pitch generally provides finer control. In addition, for a groove 86 with a small pitch, the wall of the groove 86 is very nearly flat as experienced by the pin 88, and consequently there is little tendency of the stem 84 to rotate “downhill”, i.e. to be rotated and pushed out of the valve 20 by the internal fluid pressures.

In a preferred embodiment, the pitch of the helical groove 86 is such that the fluid control valve 20 is adapted to reliably produce fluid concentrations suitable for concentrations ranging from 0.1% to 3%.

In another preferred embodiment, the pitch of the helical groove 86 is not steeper than 0.003 inches of stroke at the valve head 22 for a one degree rotation of the valve stem 84.

In yet another preferred embodiment, the pitch of the helical groove 86 is such that the valve stem 84 engages the positioning pin 88 to such a degree that the fluid pressures experienced by the valve 20 in operation are insufficient to cause linear movement of the valve stem (and consequently of the valve head 22).

In certain embodiments, the pitch of the helical groove 86 may vary along its length. For example, the helical groove 86 may have a relatively shallow pitch in one portion to provide extremely fine control over the relative flow amount of the second fluid compared to the first fluid over one range of values, and less fine control over another range of values.

More particularly, the helical groove 86 may have a relatively shallow pitch in one portion so as to finely control the relative flow amount of the second fluid in a range of 0.1% to 1% for class A foams, and may have a less shallow pitch in another portion so as to less finely control the relative flow amount of the second fluid in a range of 1% to 3% for class B foams.

However, such an arrangement is exemplary only.

The length of the helical groove 86 also is determined in part by the diameter of the valve stem 84 in the area of the groove 86. As the diameter increases the circumference of the valve stem 84 also increases, and so the length of the helical groove increases, assuming the number of turns the groove 86 makes around the valve stem 84 remains the same. Also, increasing the diameter of the valve stem 84 in the area of the groove 86 enables further decreases in the pitch of the helical groove.

As illustrated, the valve stem 84 includes a thicker shaft portion 90 with the helical groove 86 defined therein. Such an arrangement increases the diameter of the valve stem 84 in that area, allowing for a longer helical groove 86. However, this is exemplary only.

Also as shown, the manual interface 21 is in the form of a knob connected to the end of the valve stem 84 that is opposite the valve head 22. However, this also is exemplary only.

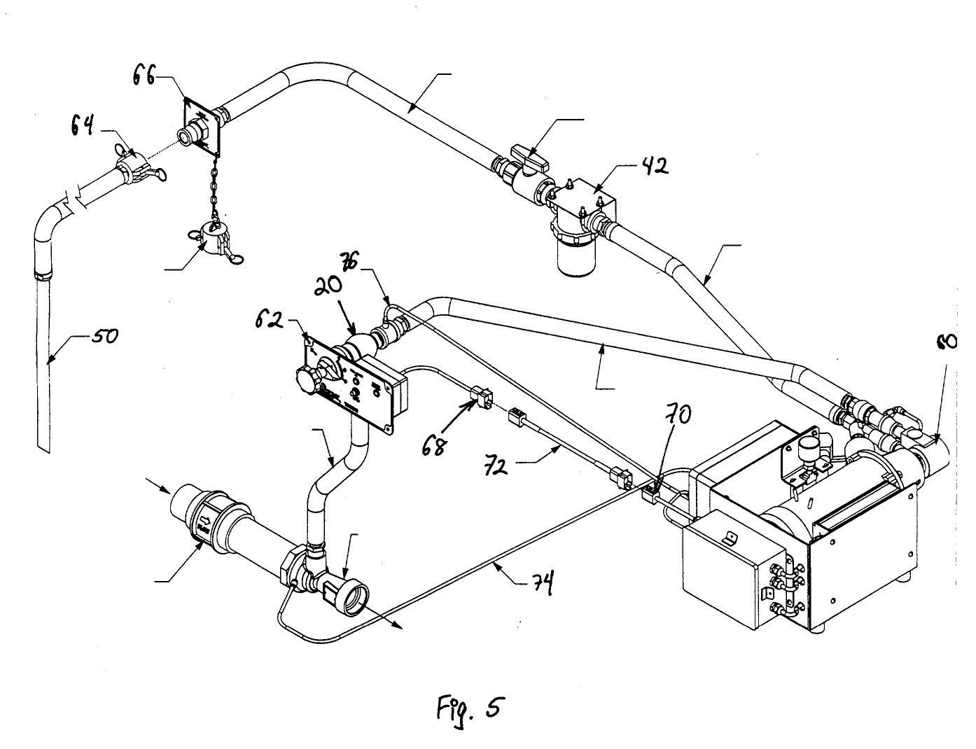

In certain embodiments, the system may be made in modules. In an exemplary embodiment, such as that illustrated in FIG. 5, the system may include an active module 60 and a control module 62.

In the system illustrated in FIG. 5, the control module 62 includes the interface 21. As shown, the control module 62 also includes the fluid control valve 20, however, this is exemplary only. Although in some embodiments the interface 21 used to operate the fluid control valve 20 is a manual interface, and thus typically is near the fluid control valve 20, in other embodiments including but not limited to embodiments wherein the interface is not a manual interface, the fluid control valve 20 may be some distance from the interface 21.

In addition, the control module 62 may include other features, such as hose fittings, mounting brackets, etc. (not separately identified in FIG. 5).

The active module 60 includes most or all of the other active components of the system, except for the fluid control valve 20. Thus, in the embodiment illustrated, the control computer 30, the pressure transducers 32a and 32b, the motor drive 34, the motor 36, and the fluid pump 40. These individual components, being assembled into a single unit, are not illustrated or identified individually in FIG. 5. As with the control module 62, the active module 60 may include other features, such as hose fittings, mounting brackets, housings or enclosures for individual components, etc.

As illustrated in FIG. 5, first and second fluid sensing lines 74 and 76 extend from points upstream of the first restriction area 12b and the second restriction area 28 (not visible), respectively. Thus, pressure transducers 32a and 32b (not visible) may be disposed within the active module 60 and still measure pressures at the appropriate points. However, such an arrangement is exemplary only, and other arrangements whereby pressure transducers may measure pressure at the necessary locations while being themselves remote from those locations may be equally suitable.

In a modular system, passive components, that is, components which are not actively controlled during operation of the system, may be arranged elsewhere. Typical passive components include, but are not limited to, hoses and their connectors, the filter 42, the pick up tube 50, etc.

The system may be produced in kit form with such modules. Such kits may be advantageous for certain applications, such as retrofitting, or on-site assembly. In addition, such kits may be quickly assembled and/or installed, even by persons without special training. Thus, such kits may be especially suitable both for incorporation into the construction of a larger assembly, i.e. a firefighting vehicle, and for assembly into a self-contained unit.

As shown in FIG. 5, the control module 62 may be located some distance from the active module 60. Although the distance shown is relatively short, it will be appreciated that the modules as shown may be separated by essentially any distance, so long as they are connected for communication and fluid flow. For example, the active module could be on or near the back of a firefighting vehicle, while the control module 62 could be located inside the vehicle, i.e. on the instrument panel, so as to be easily controlled and monitored by a person remaining in or near the vehicle, or the control module 62 could be located near the outlet of the fire suppression system, so as to be readily controlled by the person or persons in(proximity to the fire.

Although such an arrangement is illustrated for a modular system in FIG. 5, the ability to separate the components that make up the active module 60 and the control module 62 is not limited only to modular systems. For example, even if the control computer 30 is not part of an active module 60 and the interface 21 is not part of a control module 62, it still may be possible (though not required) to separate the interface 21 from the control computer 30 by some distance.

As illustrated in FIG. 5, the pick up tube 50 may be separate from the remainder of the system. As shown, the pick up tube 50 is equipped with a first part 64 of a coupler, and the section of hose leading to the active module 60 is equipped with a second part 66 of the coupler. As is illustrated in FIG. 1, the pick up tube 50 is in communication with the fluid source 44 (not shown in FIG. 5). Thus, the system may be readily connected to and disconnected from fluid sources.

Such an arrangement enables convenient changing between two or more sources with different fluids therein, changing from an empty fluid source to a full fluid source, and connection with fluid sources that are separate from the remainder of the system.

In addition, the ability to readily connect to different fluid sources 44 in turn enables significant flexibility in terms of the types of fluid source 44 that may be used, and the manner in which they may be transported, arranged, and stored while still remaining ready for use. For example, “pails” of foam concentrate may be prepared in advance, equipped with pick up tubes, closed or sealed, and stored for later use. In particular, such pails could be carried in the equipment storage space of a firefighting vehicle, even one that is not otherwise equipped for foam use.

However, such an arrangement is exemplary only; it is not necessary for each fluid source 44 to have its own pick up tube 50. Other arrangements may be equally suitable. In particular, it is noted that other arrangements may also allow for ready changes from one fluid source to another, including but not limited to the use of a single pick up tube 50 that is moved from fluid source to fluid source.

Certain embodiments, including but not limited to embodiments having a modular construction as previously described, may include so-called “plug and play” electrical connections. For example, as illustrated in FIG. 5, the active module 60 and the control module 62 each have plug connectors 68 and 70 attached thereto. In the embodiment shown, the plug connectors 68 and 70 engage a connecting harness 72, also fitted with plugs. Electrical connection is a matter of plugging together connectors 68 and 70 with 72. Although the connecting harness 72 in FIG. 5 is shown to be relatively short, it will be appreciated that this is illustrative only, and that the harness may be of essentially any length. Thus, even if the control module 62 is a considerable distance from the active module as described previously, the a connecting harness as described herein may still be used.

In a preferred embodiment, the plug connectors 68 and 70 and the connecting harness 72 are adapted to make watertight connections, so as to exclude water therefrom. In another preferred embodiment, the plug connectors 68 and 70 and the connecting harness 72 have unique plug connections. That is, they are adapted to fit together only with the correct mating plug and in the correct position, i.e. by designing the plugs thereof with unique shapes.

Although the plug connectors 68 and 70 and the connecting harness 72 are illustrated for a modular system in FIG. 5, the use of such components is not limited only to modular systems. For example, even if the control computer 30 is not part of an active module 60 and the interface 21 is not part of a control module 62, it still may be possible (though not required) to connect the units with plug-and-play connections, as described.

In addition, it is noted that both plug-and-play connections, and also electrical connections of any sort, are exemplary only. For example, a system similar to that illustrated in FIG. 5 could incorporate separate power sources (i.e. batteries) in the active module 60 and control module 62, rather than have power connections therebetween, and/or could use wireless communication (i.e. radio) between the active module 60 and control module 62. In such a system, no electrical connections, either plug-and-play or otherwise, would be required.

Certain embodiments, including but not limited to those having a modular construction as described previously, may furthermore be arranged as a complete, ready-for-use kit, for example disposed on a carriage or storage unit. One type of such carriage is referred to with respect to fire fighting applications as a skid. Although the precise form of a skid may vary, typically it includes a housing in the shape of a box, with or without a cover, and feet, commonly made of or padded with a resilient material such as rubber to isolate vibrations.

Certain embodiments of the claimed invention, including but not limited to those disposed on a skid, may be adapted for stand-alone use. For example, if the components illustrated in FIG. 5 were disposed together on a skid, it would not be necessary to mount them or otherwise dispose them on a vehicle. Power could be supplied either externally via a power connection, or internally from a generator, battery, etc. A fluid source 44 likewise could be external or internal. Even water, though commonly supplied externally from a fire hydrant, tank truck, etc. could also be supplied internally, through an on-board tank. Thus, the entire assembly could be arranged as a single unit. In addition to the use of a skid as described above, such a self-contained system could be mounted on a trailer, cart, etc., and used without other firefighting vehicles or support equipment.

However, this application is merely exemplary, as the present invention may also be incorporated in residential or small commercial buildings using foam based fire protection, for instance, an existing overhead sprinkler system, or a mixing application not at all related to fire fighting, such as blending gasoline.

The present invention provides a fire suppression apparatus that accurately proportions an amount of foam to be mixed with water. In this manner, mixing proportions can be precise, eliminating waste of foam concentrates, providing a cost effective apparatus. Also, the apparatus provides flexibility, and enables convenient retrofitting and use in portable or self-contained systems. In addition, the control valve of provides a pressure balanced configuration to help facilitate maintaining the pressure of the first water fluid flow equal to the pressure of the second foam fluid flow.

The above specification, examples and data provide a complete description of the manufacture and use of a preferred embodiment of the invention. Since many embodiments of the invention can be made without departing from the spirit and scope of the invention, the invention resides in the claims hereinafter appended.

What is claimed is:

1. An apparatus for mixing fluids, comprising:
a fluid delivery line adapted to communicate with a first fluid source;
a ratio controller disposed within the fluid delivery line, the ratio controller comprising a first restriction area, the first restriction area being adapted to receive a second fluid;
a flow control valve in communication with the fluid delivery line at the first restriction area, the flow control valve comprising an area controlling device having an adjustable second restriction area;
an electrically driven fluid pump introducing the second fluid from a second fluid source, the fluid pump being connected to the flow control valve to deliver the second fluid to the first restriction area via the second restriction area;
a pressure sensing module sensing a pressure of the first fluid upstream of the first restriction area, and sensing a pressure of the second fluid upstream of the second restriction area;
an interface for setting a relative flow amount of the second fluid compared to the first fluid; and
a control computer in communication with the pressure sensing module and the fluid pump, the control computer processing the pressures measured from the pressure sensing module, the control computer sending command signals to the fluid pump to modulate the pressure of the second fluid such that the pressure of the second fluid is maintained substantially equal to the pressure of the first fluid;
whereby when the pressures of the first and second fluids are substantially equal, a ratio defined by the first restriction area to the second restriction area determines the relative flow amount of the second fluid compared to the first fluid.

2. The apparatus according to claim 1, wherein the apparatus is a fire fighting apparatus, the first fluid is water, and the second fluid is a firefighting foam concentrate.

3. The apparatus according to claim 1, wherein the pressure sensing module comprises first and second pressure transducers, the first pressure transducer sensing the pressure from the flow of the first fluid from the first fluid source, the second pressure transducer sensing the pressure from the flow of the second fluid from the second fluid source, wherein the control computer is operatively connected with the first and second pressure transducers, and the control computer processes the pressures measured from the first and second pressure transducers.

4. The apparatus according to claim 1, wherein the control computer uses an algorithm based on the pressures of the first and second fluids to determine the command signals to send to the fluid pump.

5. The apparatus according to claim 1, wherein gravity feed from the second fluid source is not required.

6. The apparatus according to claim 1, wherein the pump generates sufficient force to pull the second fluid upward a vertical distance from the second fluid source.

7. The apparatus according to claim 1, wherein the pump generates sufficient force to pull the second fluid upward a vertical distance of at least six feet from the second fluid source.

8. The apparatus according to claim 1, further comprising a pick up tube adapted to provide fluid communication between the second fluid source and the fluid pump.

9. The apparatus according to claim 1, wherein the pump is adapted to pump either type A firefighting foam or type B firefighting foam as a second fluid.

10. The apparatus according to claim 1, wherein the flow control valve is adapted controllably dispense either type A firefighting foam or type B firefighting foam as a second fluid.

11. The apparatus according to claim 1, wherein the flow control valve is adapted to controllably dispense the first and second fluids such that a concentration of the second fluid at least includes a range of 0.1% to 3%.

12. The apparatus according to claim 1, wherein the flow control valve comprises:
a valve body defining an outflow opening therein, and a valve stem having an end thereof disposed at least partially in the outflow opening so as to control a flow of the second fluid therethrough, the outflow opening and the valve stem end cooperating to comprise the second restriction area, wherein the second restriction area is a portion of the outflow opening that is unobstructed by the valve stem end;
a helical groove defined in the valve stem; and
a positioning pin connected to the body and engaged with the helical groove, such that rotating the valve stem causes the stem to move linearly so as to change the portion of the outflow opening that is unobstructed by the valve stem end.

13. The apparatus according to claim 12, wherein:
a pitch of the helical groove is such that the flow control valve is adapted to controllably dispense the first and second fluids such that a concentration of the second fluid at least includes a range of 0.1% to 3%.

14. The apparatus according to claim 12, wherein:
a pitch of the helical groove is not steeper than 0.003 inches per degree of rotation.

15. The apparatus according to claim 12, wherein:
a pitch of the helical groove is such that valve stem engages the positioning pin to such a degree that operating pressures are insufficient to cause linear movement of the valve stem.

16. The apparatus according to claim 12, wherein a pitch of the helical groove varies along a length of the helical groove.

17. The apparatus according to claim 1, wherein the ratio controller includes a diameter corresponding to a diameter of the fluid delivery line.

18. The apparatus according to claim 12, wherein the valve stem comprises a thicker shaft portion with the helical groove defined therein.

19. The apparatus according to claim 18, wherein a diameter of the ratio controller is approximately 2.0 inches to about 8.0 inches.

20. The apparatus according to claim 19, wherein the diameter of the ratio controller is approximately 2.5 inches and a diameter of the first restriction area is approximately 1.155 inches at a center of the first restriction area.

21. The apparatus according to claim 1, wherein the first restriction area is defined by a ported annulus extending inward from an inner sidewall of a portion of the fluid delivery line.

22. The apparatus according to claim 1, wherein the first restriction area defines a venturi section.

23. The apparatus according to claim 1, wherein the first restriction area is a tapered restriction.

24. The apparatus according to claim 23, wherein the tapered restriction is a smoothly-tapered restriction.

25. The apparatus according to claim 21, wherein the first restriction area comprises a restriction vortex, the restriction vortex defining a low-pressure area, and wherein the ported annulus is disposed at the restriction vortex permitting access to the low-pressure area.

26. The apparatus according to claim 25, wherein the fluid control valve is a variable cone valve.

27. The apparatus according to claim 1, further comprising waterproof electrical connections between the interface and at least one of the group consisting of the pressure sensing module, the control computer, the fluid pump, and the motor.

28. The apparatus according to claim 1, further comprising unique plug connections between the interface and at least one of the group consisting of the pressure sensing module, the control computer, the fluid pump, and the motor.

29. The apparatus according to claim 1, wherein the interface is distal from at least one of the group consisting of the pressure sensing module, the control computer, the fluid pump, and the motor.

30. The apparatus according to claim 1, wherein the interface is incorporated into a control module, and at least one of the group consisting of the pressure sensing module, the control computer, the fluid pump, and the motor are incorporated into an active module.

31. The apparatus according to claim 1, further comprising a skid, wherein at least the one of the group consisting of the pressure sensing module, the control computer, the fluid pump, and the motor are disposed in the skid.

32. The apparatus according to claim 31, wherein the interface is disposed on the skid.

33. A kit for a fluid mixing apparatus, comprising:
a control module, comprising:
an interface for setting a relative flow amount of a second fluid compared to a first fluid;
a fluid control valve in communication with the interface, the fluid control valve being adapted to receive the second fluid therein, the fluid control valve comprising an area controlling device having an adjustable second restriction area; and
an active module, comprising:
a ratio controller adapted to be disposed within a fluid delivery line for the first fluid from a first fluid source, the ratio controller comprising a first restriction area, the first restriction area being adapted to receive the second fluid via the second restriction area;
an electrically driven fluid pump adapted to introduce the second fluid from a second fluid source, the fluid pump being connected to the flow control valve to deliver the second fluid to the first restriction area via the second restriction area;
a pressure sensing module sensing a pressure of the first fluid upstream of the first restriction area, and sensing a pressure of the second fluid upstream of the second restriction area; and
a control computer in communication with the pressure sensing module and the fluid pump, the control computer processing the pressures measured from the pressure sensing module, the control computer sending command signals to the fluid pump to modulate the pressure of the second fluid such that the pressure of the second fluid is maintained substantially equal to the pressure of the first fluid;
whereby when the pressures of the first and second fluids are substantially equal, a ratio defined by the first restriction area to the second restriction area determines the relative flow amount of the second fluid compared to the first fluid.

34. The kit according to claim 33, wherein:
the fluid control valve is incorporated into the control module.

35. The kit according to claim 33, further comprising waterproof electrical connections between the interface and at least one of the group consisting of the pressure sensing module, the control computer, the fluid pump, and the motor.

36. The kit according to claim 33, further comprising unique plug connections between the interface and at least one of the group consisting of the pressure sensing module, the control computer, the fluid pump, and the motor.

37. A method of mixing fluids, comprising the steps of:
providing a delivery line, the delivery line comprising a first restriction area;
introducing a first fluid into the delivery line at a first pressure;
providing a fluid control mechanism for a second fluid, comprising an electrically driven fluid pump and a flow control valve comprising an adjustable second restriction area;
introducing a second fluid at a second pressure for delivery to the first restriction area via the second restriction area;
measuring the first and second fluid pressures with a pressure sensing module;
processing the first and second fluid pressures measured by the pressure sensing module using a control computer;
providing a feedback loop between the control computer and the fluid pump;
sending command signals from the control computer to the fluid pump to maintain the second fluid pressure substantially equal to the first fluid pressure, whereby a relative flow amount of the second fluid to the first fluid is a ratio of the first restriction area to the second restriction area; and
controlling the relative amount of the second fluid to the first fluid by controlling the second restriction area.

38. The method according to claim 37, wherein the pressure sensing module comprises first and second pressure transducers, further comprising the steps of:
measuring the first fluid pressure with the first transducer;
measuring the second fluid pressure with the second transducer.

39. The method according to claim 37, further comprising the step of:
using the fluid pump to generate sufficient force to pull the second fluid upward a vertical distance from a second fluid source.

40. The method according to claim 37, further comprising the step of:
using the fluid pump to generate sufficient force to pull the second fluid upward a vertical distance of at least six feet from a second fluid source.

41. The method according to claim 37, further comprising the step of:
using a pick up tube to convey the second fluid from a second fluid source to the fluid pump.
